(19) United States
(12) Patent Application Publication
(10) Pub. No.: US 2021/0110798 A1
(43) Pub. Date: Apr. 15, 2021

(54) GUITAR STRAP AND METHOD OF USE

(71) Applicant: Austin Franzen, Dallas, TX (US)

(72) Inventor: Austin Franzen, Dallas, TX (US)

(21) Appl. No.: 17/017,930

(22) Filed: Sep. 11, 2020

Related U.S. Application Data
(60) Provisional application No. 62/873,318, filed on Jul. 12, 2019.

(51) Int. Cl. G10G 5/00; F16B 1/00

(52) U.S. Cl. CPC G10G 5/005; F16B 1/00

(57) ABSTRACT

A guitar strap system includes a guitar having a first knob and a second knob; a retractable strap, having a housing having a retraction mechanism enclosed therein and having a first opening; a strap housed within the housing and extending through the first opening; a first connector attached to the strap at a first end; and a second connector attached to the housing; the first connector and the second connector are to engage with the first knob and the second knob.

### BACKGROUND

### 1. Field of the Invention

The present invention relates generally to guitar straps, and more specifically, to a retractable guitar strap for providing a convenient system that includes a strap that is compact.

### 2. Description of Related Art

Guitar straps are well known in the art and are effective means to aid a user in supporting a guitar. For example, FIG. 1 depicts a conventional system 101 in which a guitar strap 103 is secured to a guitar 105 via a first knob 107 and a second knob 109. The user can then place the strap around their neck/back for support.

One of the problems commonly associated with system 101 is limited use. For example, the user may end up wanting the guitar strap attached and removed at various times, this then requires that they transport the strap, which can be inconvenient and can further lead to damage of the strap.

It is therefore an object of the present invention to provide for a guitar strap that is compact and easy to transport, while still being convenient to add and remove, thereby providing an improvement over the prior art.

Accordingly, although great strides have been made in the area of guitar straps, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common guitar strap system;

FIG. 2 is a side view of a retractable guitar strap in accordance with the present application;

FIG. 3 is a top view of the retractable guitar strap of FIG. 2; and

FIG. 4 is a flowchart of the method of use of the retractable guitar strap of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional guitar strap systems. Specifically, the present invention provides for a retractable guitar strap that can be easily transported and added to a guitar as needed by the user. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

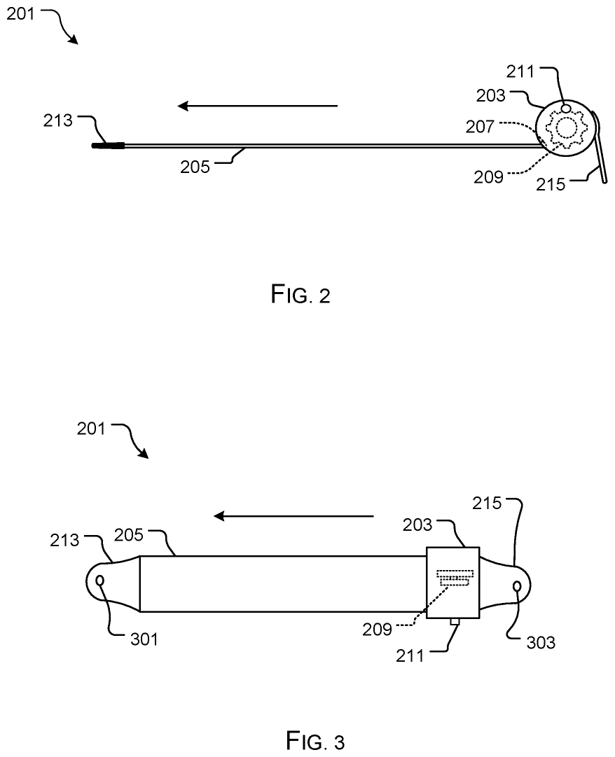

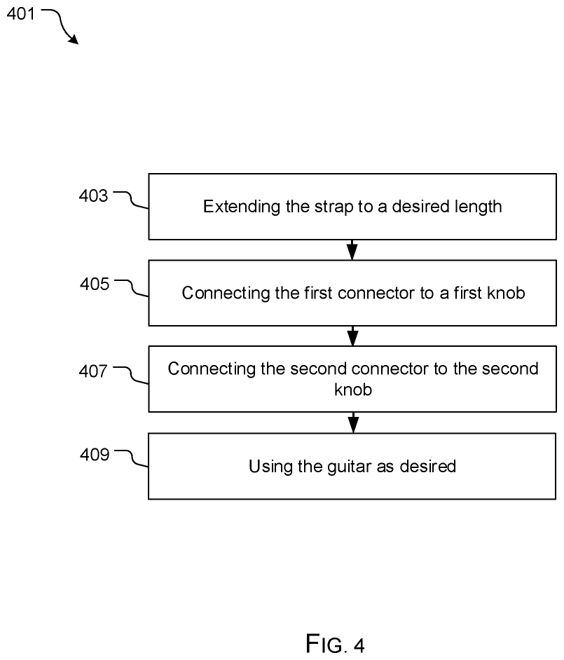

Referring now to the drawings wherein like reference characters identify corresponding or similar elements throughout the several views, FIGS. 2 and 3 depict side and top views of a retractable guitar strap 201 in accordance with a preferred embodiment of the present application. It will be appreciated that system 201 overcomes one or more of the above-listed problems commonly associated with conventional guitar straps.

In the contemplated embodiment, retractable strap 201 includes a housing 203 that is composed of any suitable material, such as a rubber and plastic combination. The housing 203 can vary in shape and size, however, it is contemplated that the preferred embodiment is cylindrical in shape and is less than 2 inches in diameter and 2 inches in length, thereby being convenient for carrying in a pocket or the like. Retractable strap 201 further includes a strap 205 that is engaged with the housing 203 via an opening 207, wherein the strap 205 is configured to extend and contract from the opening and thereby be stored within the housing. It should be appreciated that the strap can vary in size as needed for aesthetical, functional, or manufacturing consideration. In the preferred embodiment, the strap is composed of nylon, however it is contemplated that other suitable materials may be used.

System 201 further includes a retraction mechanism 209 housed within an interior of the housing, the retraction mechanism 209 being configured to pull the strap back into the housing for storage. It is contemplated that any suitable means of retraction could be used, such as one or more gears, springs, or the like. System 201 further includes a locking mechanism 211 that is configured to lock the strap 205 at a desired distance. The locking mechanism 211 can be used to stop the retraction mechanism as needed.

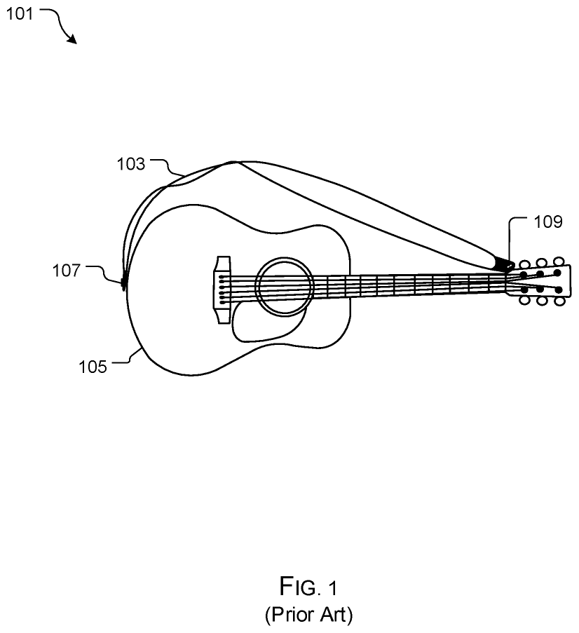

System 201 further includes a first connector 213 attached to the strap 205, the first connector 213 configured to connect to a knob associated with the guitar (refer to FIG. 1). A second connector 215 is attached to the back of the housing 203 and configured to engage with a second knob of the guitar. The first and second connectors can vary in style, and can include a connection device 301, 303 such as an opening configured to engage with the knob. Alternative embodiments could include elements such as pinch/claw mechanisms.

It should be appreciated that one of the unique features believed characteristic of the present application is the use of a retraction device to house a strap within the housing when not in use. Another unique feature believed characteristic of the present application is the use of a universal connection device, such as a clamp, that provides for easy attachment to the knobs.

In FIG. 4, a flowchart 401 depicts the method of use of the strap of the present application. The user can extend the strap to a desired length and lock the strap in place as desired, as shown with box 403. The user connects the first connector and the second connector to the knobs of the guitar, as shown with boxes 405, 407. The user can proceed to use the guitar as desired and can store the strap in the housing when not in use, as shown with box 409.

In some embodiments, the strap can be interchangeable within the housing, thereby allowing for a user to change out different designs.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A guitar strap system, comprising:
a guitar having a first knob and a second knob;
a retractable strap, having:
a housing having a retraction mechanism enclosed therein and having a first opening;
a strap housed within the housing and extending through the first opening;
a first connector attached to the strap at a first end; and
a second connector attached to the housing;
wherein the first connector and the second connector are configured to engage with the first knob and the second knob.

2. The system of claim 1, wherein the housing is composed of a durable rubber and plastic mix.

3. The system of claim 1, wherein the first connector is a pad having an opening extending therethrough, the opening configured to engage with the first knob.

4. The system of claim 1, wherein the strap is composed of nylon.

5. The system of claim 1, wherein the housing further includes a locking mechanism configured to lock the strap at a desired length.

6. The system of claim 1, wherein the retraction mechanism includes one or more gears.

7. A method of playing a guitar, the method comprising:
providing a retractable strap having a housing with a retraction mechanism enclosed therein and having a first opening; a strap housed within the housing and extending through the first opening; a first connector attached to the strap at a first end;
and a second connector attached to the housing;
extending the strap from the housing to a desired length;
securing the first connector to a first knob on the guitar; and
securing the second connector to a second knob on the guitar.
